(19) United States
(12) Patent Application Publication
(10) Pub. No.: US 2026/0205797 A1
(43) Pub. Date: Jul. 16, 2026

(54) TERMINAL CAPABILITY REPORTING METHOD AND APPARATUS, DEVICE, AND STORAGE MEDIUM

(71) Applicant: Beijing Xiaomi Mobile Software Co., Ltd., Beijing (CN)

(72) Inventor: Yumin WU, Beijing (CN)

(21) Appl. No.: 19/132,225

(22) PCT Filed: Nov. 28, 2022
(86) PCT No.: PCT/CN2022/134829

§ 371 Date: May 22, 2025

(51) Int. Cl. H04W 8/22; H04W 76/20

(52) U.S. Cl. CPC H04W 8/22; H04W 76/20

(57) ABSTRACT

A terminal capability reporting method is performed by a terminal device, and includes: sending radio capability information of the terminal device and an indicator to an access and mobility management function (AMF), wherein the indicator indicates that the radio capability information is partial radio capability information of the terminal device or full radio capability information of the terminal device.

### CROSS-REFERENCE TO RELATED APPLICATION

This application is the U.S. national phase application of International Application No. PCT/CN 2022/134829, filed on Nov. 28, 2022, the disclosure of which is incorporated herein by reference in its entirety.

### TECHNICAL FIELD

The present disclosure relates to the field of communication technologies, and in particular, relates to a terminal capability reporting method, apparatus, device and storage medium.

### BACKGROUND

In a communication system, a network device is expected to obtain radio capability information of a terminal device, so as to communicate with the terminal device according to the radio capability information. As wireless communication technologies continue to evolve, the communication technologies such as the 4th generation (4G) mobile communication technologies and the 5th generation (5G) mobile communication technologies have been successively developed, and definitions of various frequency bands, carriers and bandwidths have evolved. Radio capabilities supported by the terminal are increasing, as is the amount of data reported on the radio capability information.

### SUMMARY

According to a first aspect of the examples of the present disclosure, a terminal capability reporting method is provided, which is performed by a terminal device, and the method includes: sending radio capability information of the terminal device and an indicator to an access and mobility management function (AMF), wherein the indicator indicates that the radio capability information is partial radio capability information of the terminal device or full radio capability information of the terminal device.

According to a second aspect of the examples of the present disclosure, a terminal capability reporting method is provided, which is performed by an AMF, and the method includes: receiving radio capability information and an indicator sent by a terminal device, wherein the indicator indicates that the radio capability information is partial radio capability information of the terminal device or full radio capability information of the terminal device; determining, according to the radio capability information and the indicator, radio capability information to be sent to user equipment radio capability management function (UCMF), and sending the radio capability information to the UCMF.

According to a third aspect of examples of the present disclosure, a terminal capability reporting method is provided, which is performed by a UCMF, and the method includes: receiving radio capability information and an indicator sent by an AMF, wherein the indicator indicates that the radio capability information is partial radio capability information of a terminal device or full radio capability information of the terminal device; and updating, according to the radio capability information and the indicator received from the AMF, second local radio capability information stored in the UCMF, wherein the second local radio capability information includes the full radio capability information of the terminal device.

It is to be understood that the foregoing general description and the following detailed description are illustrative and explanatory only and are not restrictive of the present disclosure.

### BRIEF DESCRIPTION OF THE DRAWINGS

The accompanying drawings, which are incorporated in and constitute a part of this specification, illustrate examples consistent with the present disclosure and, together with the specification, serve to explain the principles of the disclosure.

FIG. 1 is a schematic diagram illustrating a communication system according to an example.

FIG. 2 is a flowchart illustrating a terminal capability reporting method according to an example.

FIG. 3 is a flowchart illustrating a terminal capability reporting method according to an example.

FIG. 4 is a flowchart illustrating a terminal capability reporting method according to an example.

FIG. 5 is a flowchart illustrating a terminal capability reporting method according to an example.

FIG. 6 is a flowchart illustrating a terminal capability reporting method according to an example.

FIG. 7 is a flowchart illustrating a terminal capability reporting method according to an example.

FIG. 8 is a flowchart illustrating a terminal capability reporting method according to an example.

FIG. 9 is a flowchart illustrating a terminal capability reporting method according to an example.

FIG. 10 is a flowchart illustrating a terminal capability reporting method according to an example.

FIG. 11 is a flowchart illustrating a terminal capability reporting method according to an example.

FIG. 12 is a flowchart illustrating a terminal capability reporting method according to an example.

FIG. 13 is a flowchart illustrating a terminal capability reporting method according to an example.

FIG. 14 is a flowchart illustrating a terminal capability reporting method according to an example.

FIG. 15 is a flowchart illustrating a terminal capability reporting method according to an example.

FIG. 16 is a flowchart illustrating a terminal capability reporting method according to an example.

FIG. 17 is a flowchart illustrating a terminal capability reporting method according to an example.

FIG. 18 is a flowchart illustrating a terminal capability reporting method according to an example.

FIG. 19 is a flowchart illustrating a terminal capability reporting method according to an example.

FIG. 20 is a flowchart illustrating a terminal capability reporting method according to an example.

FIG. 21 is a flowchart illustrating a terminal capability reporting method according to an example.

FIG. 22 is a block diagram illustrating a terminal capability reporting apparatus according to an example.

FIG. 23 is a block diagram illustrating a terminal capability reporting apparatus according to an example.

FIG. 24 is a block diagram illustrating a terminal capability reporting apparatus according to an example.

FIG. 25 is a block diagram illustrating a terminal capability reporting apparatus according to an example.

### DETAILED DESCRIPTION OF THE EMBODIMENTS

Examples will be described in detail here with the illustrations thereof illustrated in the drawings. Where the following descriptions involve the drawings, like numerals in different drawings refer to like or similar elements unless otherwise indicated. The implementations described in the following examples do not represent all implementations consistent with the present disclosure. Rather, they are merely examples of apparatuses and methods consistent with some aspects of the present disclosure as detailed in the appended claims.

It is to be noted that all operations for acquiring signals, information or data in the present disclosure are carried out in compliance with the relevant data protection laws and policies of the host country and with the authorization given by the owner of the corresponding apparatus.

In the description of the present disclosure, terms such as “first”, “second”, etc. are used to distinguish similar objects and are not necessarily understood as a specific sequence or order. Furthermore, in the description referring to the drawings, the same reference numerals in different drawings denote the same element unless otherwise indicated.

In the description of the present disclosure, unless otherwise specified, “multiple” refers to two or more than two and other quantifiers are similar, “at least one”, “one or more” or similar expressions refer to any combination of these items (pieces), including any combination of single or multiple items (pieces). For example, at least one may represent any number. For another example, one or more of a, b and c may represent: a, b, c, a-b, a-c, b-c, or a-b-c, where a, b, c may be singular or plural. Term “and/or” is a description of an association relationship of associated objects, indicating that three relationships may exist. For example, A and/or B may represent: A exists alone, A and B exist at the same time, and B exists alone, where A and B may be singular or plural.

Although being described in a specific order in the drawings, the operations or steps in the examples of the present disclosure are not to be understood as being expected to be performed in the specific order as shown or in a serial order as shown, or being expected to be all performed as shown to get a desired result. In the examples of the present disclosure, these operations or steps may be performed in any order; or, these operations or steps may be performed in parallel; or, a portion of these operations or steps may be performed.

The technical solutions provided in the examples of the present disclosure may include the following beneficial effects. A terminal device sends radio capability information of the terminal device and an indicator to an AMF, and the indicator indicates that the radio capability information is partial radio capability information of the terminal device or full radio capability information of the terminal device. In this way, the terminal device may report the partial radio capability information or the full radio capability information as required, thereby improving the flexibility of reporting the terminal radio capabilities.

An implementation environment of the examples of the present disclosure is first introduced below.

The technical solutions of the examples of the present disclosure may be applied to various communication systems. The communication systems may include one or more of the 4th generation (4G) communication systems, the 5th generation (5G) communication systems, or other future (such as 6G) wireless communication systems. The communication systems may also include one or more of public land mobile networks (PLMNs), device-to-device (D2D) communication systems, machine-to-machine (M2M) communication systems, Internet of Things (IoT) communication systems, vehicle-to-everything (V2X) communication systems or other communication systems.

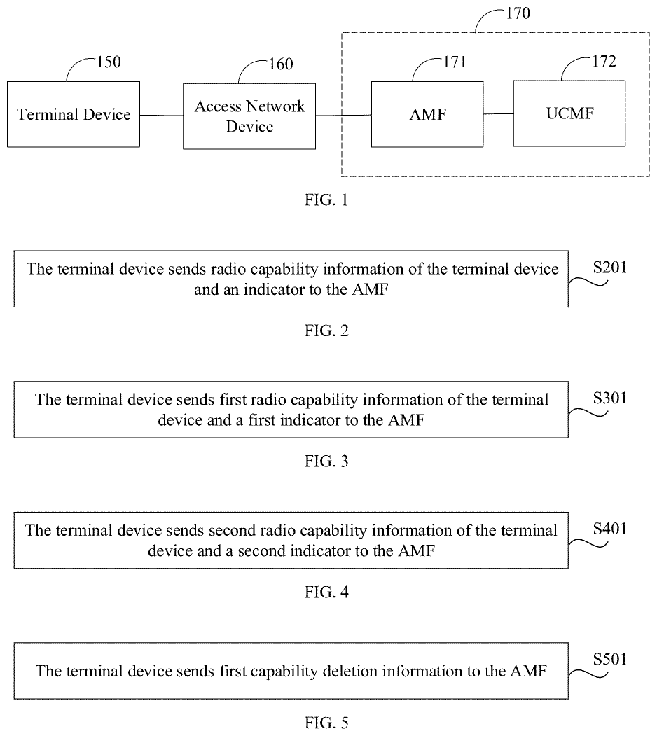

FIG. 1 is a schematic diagram of a communication system according to an example. As illustrated in FIG. 1, the communication system may include a terminal device 150, an access network device 160, and a core network device 170. The communication system may support 4G network access technologies such as long term evolution (LTE) access technologies, or support 5G network access technologies such as new radio access technologies (RATs), or support other future wireless communication technologies. The terminal device may be connected to the access network device through wireless means, and the access network device may be connected to the core network device through wireless or wired means. The core network device and the access network device may be independent and different physical devices. Alternatively, the functions of the core network device and the logical functions of the access network device may be integrated on the same physical device. Alternatively, one physical device may integrate some functions of the core network device and some functions of the access network device. It is to be noted that in the communication system, the number of the terminal devices, the access network devices or the core network devices may be one or more. The number of the terminal device, the access network device or the core network device in the communication system illustrated in FIG. 1 is only an adaptive example, and the present disclosure is not limited to it. It may be interconnected between the terminal devices, between the access network devices and between the core network devices through wired or wireless The terminal device in FIG. 1 may be an electronic device that provides voice or data connectivity. For example, the terminal device may also be called user equipment (UE), a subscriber unit, a mobile station, a station, a terminal, etc. For example, the terminal device may include a smart phone, a smart wearable device, a smart speaker, a smart tablet, a wireless modem, a wireless local loop (WLL) station, a personal digital assistant (PDA), a customer premise equipment (CPE), etc. As wireless communication technologies evolve, either the device that may access the communication system, communicate with the access network device of the communication system, communicate with other objects through the communication system, or the device among two or more devices that may communicate directly with each other may be the terminal device in the example of the present disclosure, such as a terminal or a car in intelligent transportation, a household appliance in smart homes, an electricity meter reading instrument, a voltage monitoring instrument, an environmental monitoring instrument in smart grids, a video monitoring instrument in smart security networks, and a cash register. In the examples of the present disclosure, the terminal device may communicate with the access network device, or the terminal device may communicate with the core network device via the access network device. Multiple terminal devices may also communicate with each other. The terminal device may be statically fixed or mobile, which is not limited in the present disclosure.

The access network device in FIG. 1 may support the access of the terminal device. For example, the access network device may be an evolutional Node B (eNB or eNodeB) in LTE, may be a next generation Node B (gNB or gNodeB) in a 5G network, may be a next generation radio access network (NG-RAN) device in the 5G network, and may be a base station, a broadband network gateway (BNG), an aggregation switch or a non 3rd generation partnership project (3GPP) access device in a future evolved PLMN, etc. Alternatively, or additionally, the access network device in the examples of the present disclosure may include a base station of various forms, such as a macro base station, a micro base station (also called a small station), a relay station, an access point, a 5G base station or a future base station, a satellite, a transmitting and receiving point (TRP), a transmitting point (TP), a mobile switching center, and a device that perform a base station function in D2D, M2M, IoT, V2X or other communications, etc., which is not specifically limited in the examples of the present disclosure. For the convenience of description, in all examples of the present disclosure, the devices that provide wireless communication functions for the terminal device are collectively referred to as the access network device or a base station.

The core network device in FIG. 1 may perform one or more of functions on the terminal device including mobility management, call control, session management, registration authentication, billing, etc. The core network device may include one or more functions, which may be hardware, or software divided by function, or a structure that is a combination of the two. It is to be noted that this function may also be called an entity.

In some examples of the present disclosure, as illustrated in FIG. 1, the core network device may include an access and mobility management function (AMF) 171 and a UE radio capability management function (UCMF) 172. It is to be noted that the AMF and the UCMF may be two physical devices or two functional units on the same physical device.

In some examples, the core network device may also include other functions, such as one or more of a session management function (SMF), a unified data management (UDM), a user plane function (UPF), a network exposure function (NEF) and a policy control function (PCF). The detailed functions, connection relationships and implementations of the AMF, UCMF, SMF, UDM, UPF, NEF and PCF may make reference to the relevant descriptions in the relevant technologies (such as 3GPP protocols), which are not described in detail in the present disclosure.

FIG. 2 is a flowchart illustrating a terminal capability reporting method according to an example. The method may be applied to the terminal device in the foregoing communication system. As illustrated in FIG. 2, the method may include step S201.

At S201, the terminal device sends radio capability information of the terminal device and an indicator to the AMF.

Particularly, the indicator may indicate that the radio capability information is partial radio capability information of the terminal device or full radio capability information of the terminal device.

In some examples, the radio capability information may be first radio capability information, the indicator may be a first indicator, and the first indicator may indicate that the first radio capability information is the partial radio capability information of the terminal device.

In one implementation, the first indicator may be a preset identification, which may be determined by negotiation between the terminal device and the AMF. For example, the preset identification may be an identification predefined by a protocol.

In one implementation, the first radio capability information may include part of the full radio capability information (UE radio capability information) supported by the terminal device, that is, a radio capability information subset of the terminal device. For example, the first radio capability information may include at least one of frequency band information (such as BAND1 or BAND3), standard information (such as 4G or 5G), or feature information (such as a power saving feature or a carrier aggregation (CA) feature) supported by the terminal device.

In some other examples, the radio capability information may be second radio capability information, the indicator may be a second indicator, and the second indicator may indicate that the second radio capability information is the full radio capability information of the terminal device.

In some examples, the terminal device may also send information related to a terminal identifier of the terminal device to the AMF to inform a terminal identity parameter. The terminal identity parameter may be used to uniquely identify the terminal device. For example, the terminal identity parameter may include at least one of a subscription concealed identifier (SUCI), a subscriber permanent identifier (SUPI), a globally unique temporary identifier (GUTI), a permanent equipment identifier (PEI), an international mobile equipment identity (IMEI) or an international mobile subscriber identity (IMSI). The GUTI may be a 5G-GUTI, a 4G-GUTI, or a GUTI under another network standard, which is not limited in the present disclosure.

Through the method, the terminal device may send the radio capability information of the terminal device and the indicator to the AMF, and the indicator indicates that the radio capability information is the partial radio capability information of the terminal device or the full radio capability information of the terminal device. In this way, the terminal device may report the partial radio capability information or the full radio capability information as required, thereby improving the flexibility of reporting the terminal radio capabilities.

In some examples of the present disclosure, in a case that all the radio capabilities are expected to be reported, the terminal device may send the full radio capability information of the terminal device to the AMF without sending the indicator; and in a case that the partial radio capability information is expected to be reported, the terminal device may send the partial radio capability information of the terminal device and the first indicator to the AMF.

FIG. 3 is a flowchart illustrating a terminal capability reporting method according to an example. As illustrated in FIG. 3, the method may include step S301.

At S301, the terminal device sends first radio capability information of the terminal device and a first indicator to the AMF.

Particularly, the first indicator may indicate that the first radio capability information is partial radio capability information of the terminal device.

In some examples, the first indicator may be a preset identification, which may be determined by negotiation between the terminal device and the AMF. For example, the preset identification may be an identification predefined by a protocol.

In some examples, the first radio capability information may include part of the full radio capability information (UE radio capability information) supported by the terminal device, that is, a radio capability information subset of the terminal device. For example, the first radio capability information may include at least one of frequency band information (such as BAND1 or BAND 3), standard information (such as 4G or 5G), or feature information (such as a power saving feature or a carrier aggregation feature) supported by the terminal device.

Through the method, the terminal device may send the first radio capability information of the terminal device and the first indicator to the AMF, and the first indicator indicates that the first radio capability information is the partial radio capability information of the terminal device. In this way, the terminal device may report only the partial radio capability information, instead of reporting the full radio capability information, which may reduce the occupation of wireless resources and improve the communication efficiency of the communication system.

In some examples of the present disclosure, when the partial radio capability information changes, the terminal device may determine the first radio capability information according to the changed partial radio capability information, and send the first radio capability information and the first indicator to the AMF.

Particularly, the first indicator may indicate that the first radio capability information is the partial radio capability information of the terminal device.

In some examples, the terminal device may change part of the radio capability information according to changes in network parameters and/or terminal parameters. In a case that the partial radio capability information of the terminal device changes, the partial radio capability information that changes may be taken as the first radio capability information, while the unchanged radio capability information may not be taken as the first radio capability information.

The network parameters may include at least one of a PLMN, a location area identifier (such as a tracking area identifier (TA ID)), a network standard parameter such as 4G or 5G, or a frequency band parameter.

In some examples, in a case that the PLMN changes, the terminal device may determine the changed partial radio capability information according to a preset correspondence between PLMNs and pieces of radio capability information, and take the changed partial radio capability information as the first radio capability information.

For example, a full set of the radio capability information corresponding to a first PLMN is A, and a full set of radio capability information corresponding to a second PLMN is B. When the PLMN of the terminal device changes from the first PLMN to the second PLMN, the terminal device may compare A and B, and take the partial radio capability information of B that has changed relative to A as the first radio capability information.

The terminal parameters may include one or more of power parameters or application parameters of the terminal device.

In some examples, the power parameters may include a remaining power ratio of the terminal device (whose value may be any value between 0% and 100%), and the terminal device may enable a power saving function (e.g., enabling a discontinuous reception (DRX) function) in a case that the power parameter is less than or equal to a first power threshold, and disable the power saving function (e.g., disabling the DRX function) in a case that the power parameter is greater than or equal to a second power threshold. Particularly, the second power threshold may be greater than the first power threshold. For example, the first power threshold may be 30% or 20%, and the second power threshold may be 35% or 50%.

In this way, the terminal device may determine whether the power saving function has changed based on the power parameters. In a case that the power saving function of the terminal device changes (for example, from being enabled to being disabled, or from being disabled to being enabled), the capability information related to the power saving function of the terminal device (for example, a parameter related to the DRX function) may be taken as the first radio capability information.

In some examples, the application parameters may indicate applications (APPs) currently enabled by the terminal device. The terminal device may change the partial radio capability information according to the change of the application parameters. For example, in a case that the terminal device enables a video APP, it may enable a related traffic enhancement function (such as enabling a CA function), or it may disable the power saving function (such as disabling the DRX function); and in a case that the terminal device disables the video APP, it may disable the related traffic enhancement function (such as disabling the CA function), or it may enable the power saving function (such as enabling the DRX function). In this way, the terminal device may adaptively adjust the terminal capabilities based on the application parameters, with taking into account both power consumption and traffic experience requirements.

Thus, in the case that only part of the radio capabilities have changed, the terminal device may report only the changed partial radio capability information, instead of reporting the full radio capability information, which may reduce the occupation of wireless resources and improve the communication efficiency of the communication system.

FIG. 4 is a flowchart illustrating a terminal capability reporting method according to an example. As illustrated in FIG. 4, the method may include step S401.

At S401, the terminal device sends second radio capability information of the terminal device and a second indicator to the AMF.

Particularly, the second indicator may indicate that the second radio capability information is full radio capability information of the terminal device.

In this way, the terminal device may report the full radio capability information.

FIG. 5 is a flowchart illustrating a terminal capability reporting method according to an example. As illustrated in FIG. 5, the method may include step S501.

At S501, the terminal device sends first capability deletion information to the AMF.

Particularly, the first capability deletion information indicates that part of radio capabilities of the terminal device are disabled.

In this way, in a case that the terminal device deletes or disables the part of radio capabilities, it may notify the AMF through the first capability deletion information.

The first capability deletion information may include one or more disabled radio capabilities. For example, the terminal device may disable the support for a specific frequency band (for example, it no longer supports BAND3) and may notify the AMF through the first capability deletion information. For another example, the terminal device may disable a specific network standard (such as 3G, 4G or 5G), that is, it no longer supports the specific network standard, and may notify the AMF through the first capability deletion information.

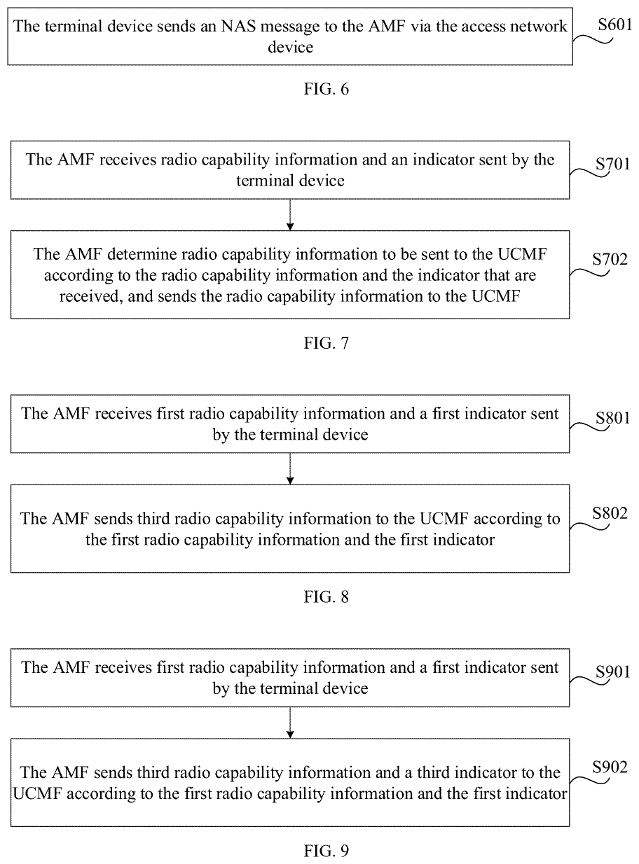

FIG. 6 is a flowchart illustrating a terminal capability reporting method according to an example. As illustrated in FIG. 6, the method may include step S601.

At S601, the terminal device sends a non-access stratum (NAS) message to the AMF via the access network device.

Particularly, the NAS message may include the radio capability information and the indicator. The indicator may indicate that the radio capability information is partial radio capability information of the terminal device or full radio capability information of the terminal device.

In some examples, the NAS message may include the first radio capability information and the first indicator.

In some other examples, the NAS message may include the second radio capability information and the second indicator.

In some other examples, the NAS message may include the first capability deletion information.

In some other examples, the NAS message may include the first radio capability information, the first indicator and the first capability deletion information.

In some examples, the NAS message may include a registration request message.

In some other examples, the NAS message may include a radio capability information update message.

In this way, the terminal device may report the full radio capability information of the terminal device or the partial radio capability information of the terminal device to the AMF through the NAS message (such as the registration request message or the radio capability information update message).

In some examples, the NAS message may also include a terminal identity parameter, which may be used to uniquely identify the terminal device. For example, the terminal identity parameter may include at least one of an SUCI, an SUPI, a GUTI, a PEI, an IMEI or an IMSI. The GUTI may be a 5G-GUTI, a 4G-GUTI, or a GUTI under another network standard, which is not limited in the present disclosure.

FIG. 7 is a flowchart illustrating a terminal capability reporting method according to an example. The method may be applied to the AMF in the foregoing communication system. As illustrated in FIG. 7, the method may include steps S701-S702.

At S701, the AMF receives radio capability information and an indicator sent by the terminal device.

Particularly, the indicator indicates that the radio capability information is partial radio capability information of the terminal device or full radio capability information of the terminal device.

In some examples, the radio capability information may be first radio capability information, the indicator may be a first indicator, and the first indicator may indicate that the first radio capability information is the partial radio capability information of the terminal device.

In one implementation, the first indicator may be a preset identification, which may be determined by negotiation between the terminal device and the AMF. For example, the preset identification may be an identification predefined by a protocol.

In one implementation, the first radio capability information may include part of the full radio capability information (UE radio capability information) supported by the terminal device, that is, a radio capability information subset of the terminal device. For example, the first radio capability information may include at least one of frequency band information )such as BAND1 or BAND3), standard information (such as 4G or 5G), or feature information (such as a power saving feature or a CA feature) supported by the terminal device.

In some other examples, the radio capability information may be second radio capability information, the indicator may be a second indicator, and the second indicator may indicate that the second radio capability information is the full radio capability information of the terminal device.

At S702, the AMF determine radio capability information to be sent to the UCMF according to the radio capability information and the indicator that are received, and sends the radio capability information to the UCMF.

The AMF may directly forward the received radio capability information to the UCMF, or may process the radio capability information (e.g., converting its format) and take the processed radio capability information as the radio capability information to be sent to the UCMF.

In some examples, the AMF may take the radio capability information as the radio capability information to be sent to the UCMF, and send the radio capability information to the UCMF.

In some other examples, the AMF may update first local radio capability information stored in the AMF according to the radio capability information and the indicator, take the updated first local radio capability information as the radio capability information to be sent to the UCMF, and send the radio capability information to the UCMF. Particularly, the first local radio capability information may include the full radio capability information of the terminal device.

In some other examples, the AMF may determine, according to the radio capability information and the indicator, the radio capability information to be sent to the UCMF and an indicator to be sent to the UCMF, and send the radio capability information and the indicator to the UCMF. The indicator to be sent to the UCMF may indicate that the radio capability information to be sent to the UCMF is the partial radio capability information of the terminal device or the full radio capability information of the terminal device. For example, the AMF may take the received radio capability information as the radio capability information to be sent to the UCMF, and take the received indicator as the indicator to be sent to the UCMF.

In some examples, the radio capability information sent by the AMF to the UCMF may include third radio capability information or fourth radio capability information. The third radio capability information may be the partial radio capability information of the terminal device, and the fourth radio capability information may be the full radio capability information of the terminal device.

In some other examples, the radio capability information sent by the AMF to the UCMF may include the third radio capability information, and the indicator sent to the UCMF may include a third indicator. The third indicator may indicate that the third radio capability information is the partial radio capability information of the terminal device.

In some other examples, the radio capability information sent by the AMF to the UCMF may include the fourth radio capability information, and the indicator sent to the UCMF may include a fourth indicator. The fourth indicator may indicate that the fourth radio capability information is the full radio capability information of the terminal device.

In some examples, the AMF may send the radio capability information to the UCMF through a radio capability reporting message, or send the radio capability information and the indicator to the UCMF through the radio capability reporting message.

Through the method, the AMF receives the radio capability information and the indicator sent by the terminal device, determines the radio capability information to be sent to the UCMF according to the radio capability information and the indicator, and sends the radio capability information to the UCMF. Particularly, the indicator may indicate that the radio capability information is the partial radio capability information of the terminal device or the full radio capability information of the terminal device. In this way, the AMF may support the terminal device to report the partial radio capability information or the full radio capability information as required, thereby improving the flexibility of reporting the terminal radio capabilities.

FIG. 8 is a flowchart illustrating a terminal capability reporting method according to an example. The method may be applied to the AMF in the foregoing communication system. As illustrated in FIG. 8, the method may include steps S801-S802.

At S801, the AMF receives first radio capability information and a first indicator sent by the terminal device.

Particularly, the first indicator indicates that the first radio capability information is partial radio capability information of the terminal device.

At S802, the AMF sends third radio capability information to the UCMF according to the first radio capability information and the first indicator.

In some examples, the AMF may take the first radio capability information as the third radio capability information and send the third radio capability information to the UCMF.

In some other examples, the AMF may update first local radio capability information stored in the AMF according to the first radio capability information and the first indicator, take the updated first local radio capability information as the third radio capability information, and send the third radio capability information to the UCMF. Particularly, the first local radio capability information may include full radio capability information of the terminal device.

In some examples, the AMF may send the third radio capability information to the UCMF through a radio capability reporting message.

Through the method, the AMF receives the first radio capability information and the first indicator sent by the terminal device, and sends the third radio capability information to the UCMF according to the first radio capability information and the first indicator. Particularly, the first indicator indicates that the first radio capability information is the partial radio capability information of the terminal device. In this way, the AMF may support the terminal devices to report only the partial radio capability information, which may reduce the occupancy of wireless resources and improve the communication efficiency of the communication system.

FIG. 9 is a flowchart illustrating a terminal capability reporting method according to an example. As illustrated in FIG. 9, the method may include steps S901-S902.

At S901, the AMF receives first radio capability information and a first indicator sent by the terminal device.

Particularly, the first indicator indicates that the first radio capability information is partial radio capability information of the terminal device.

At S902, the AMF sends third radio capability information and a third indicator to the UCMF according to the first radio capability information and the first indicator.

Particularly, the third indicator indicates that the third radio capability information is the partial radio capability information of the terminal device. The third indicator may be the same as or different from the first indicator, which is not limited in the present disclosure.

In some examples, the AMF may take the first radio capability information as the third radio capability information, take the first indicator as the third indicator, and send the third radio capability information and the third indicator to the UCMF.

In some other examples, the AMF may convert the contents of the first radio capability information into the third radio capability information in accordance with a first preset format. The first preset format may be a format agreed upon between the AMF and the UCMF. For example, the first preset format may include an order and a combination scheme of various parameters of the radio capability information agreed upon by a protocol.

In some examples, the AMF may send the third radio capability information and the third indicator to the UCMF through a radio capability reporting message (a UE radio capability information report).

In this way, the AMF may send the partial radio capability information of the terminal device to the UCMF.

In some examples of the present disclosure, the AMF may further send fifth radio capability information to the access network device (e.g., a random access network (RAN)).

In one implementation, the AMF may take the first radio capability information as the fifth radio capability information and send the fifth radio capability information to the access network device.

In another implementation, the AMF may update first local radio capability information stored in the AMF according to the first radio capability information and the first indicator, take the updated first local radio capability information as the fifth radio capability information, and send the fifth radio capability information to the access network device. Particularly, the first local radio capability information may include the full radio capability information of the terminal device.

In some other examples of the present disclosure, the AMF may further send the fifth radio capability information and a fifth indicator to the access network device.

Particularly, the fifth indicator indicates that the fifth radio capability information is the partial radio capability information of the terminal device. The fifth indicator may be the same as or different from the first indicator, which is not limited in the present disclosure.

In one implementation, the AMF may take the first radio capability information as the fifth radio capability information.

In another implementation, the AMF may convert the format of the first radio capability information to obtain the fifth radio capability information. For example, the AMF may convert the contents of the first radio capability information into the fifth radio capability information in accordance with a second preset format. The second preset format may be a format agreed upon between the AMF and the access network device. For example, the second preset format may include an order and a combination scheme of various parameters of the radio capability information agreed upon by a protocol.

In this way, the AMF may send the partial radio capability information of the terminal device to the access network device.

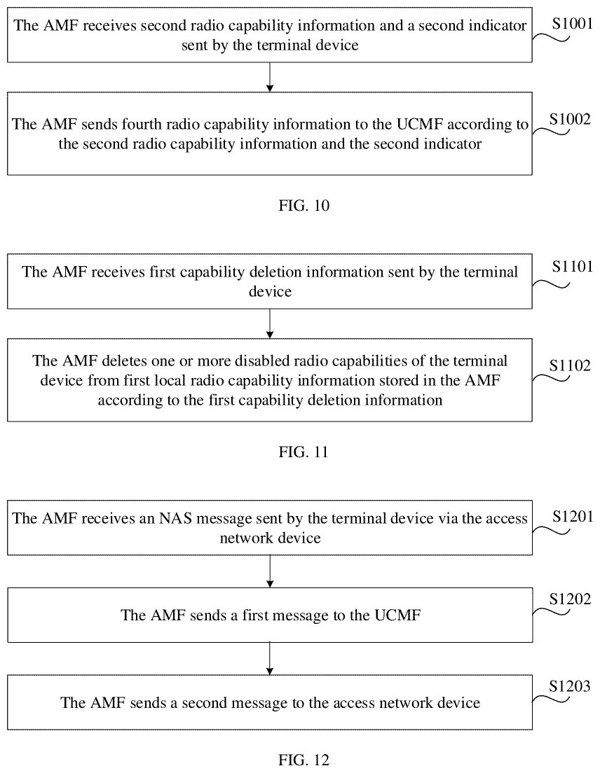

FIG. 10 is a flowchart illustrating a terminal capability reporting method according to an example. As illustrated in FIG. 10, the method may include steps S1001-S1002.

At S1001, the AMF receives second radio capability information and a second indicator sent by the terminal device.

Particularly, the second indicator indicates that the second radio capability information is full radio capability information of the terminal device.

At S1002, the AMF sends fourth radio capability information to the UCMF according to the second radio capability information and the second indicator.

In some examples, the AMF may take the second radio capability information as the fourth radio capability information and send the fourth radio capability information to the UCMF.

In some other examples, the AMF may convert the contents of the second radio capability information into the fourth radio capability information in accordance with a preset format. The preset format may be a format agreed upon between the AMF and the UCMF. For example, the preset format may include an order and a combination scheme of various parameters of the radio capability information agreed upon by a protocol.

In some other examples, the terminal device may send the fourth radio capability information and a fourth indicator to the UCMF according to the second radio capability information and the second indicator.

Particularly, the fourth indicator indicates that the fourth radio capability information is the full radio capability information of the terminal device. The fourth indicator may be the same as or different from the second indicator.

For example, the terminal device may determine the fourth radio capability information of the terminal device and the fourth indicator according to the second radio capability information and the second indicator, for example, taking the second radio capability information as the fourth radio capability information, taking the second indicator as the fourth indicator, and sending the fourth radio capability information and the fourth indicator to the UCMF.

In this way, the AMF may send the full radio capability information of the terminal device to the UCMF.

In some examples of the present disclosure, the AMF may further send sixth radio capability information to the access network device according to the second radio capability information and the second indicator.

For example, the second radio capability information may be taken as the sixth radio capability information.

In some other examples of the present disclosure, the AMF may further send the sixth radio capability information and a sixth indicator to the access network device according to the second radio capability information and the second indicator.

For example, the second radio capability information may be taken as the sixth radio capability information, and the second indicator may be taken as the sixth indicator.

In this way, the AMF may send the full radio capability information of the terminal device to the access network device.

FIG. 11 is a flowchart illustrating a terminal capability reporting method according to an example. As illustrated in FIG. 11, the method may include steps S1101-S1102.

At S1101, the AMF receives first capability deletion information sent by the terminal device.

Particularly, the first capability deletion information indicates that part of radio capabilities of the terminal device are disabled.

At S1102, the AMF deletes one or more disabled radio capabilities of the terminal device from first local radio capability information stored in the AMF according to the first capability deletion information.

Particularly, the first local radio capability information may include full radio capability information of the terminal device.

In some examples of the present disclosure, the AMF may further send new first local radio capability information to the UCMF.

Particularly, the new first local radio capability information is the first local radio capability information with the one or more disabled radio capabilities of the terminal device deleted according to the first capability deletion information.

In some other examples, the AMF may send second capability deletion information to the UCMF according to the first capability deletion information.

The second capability deletion information may be the same as or different from the first capability deletion information.

For example, the first capability deletion information may be taken as the second capability deletion information. For another example, the second capability deletion information may be obtained by converting the format of the first capability deletion information.

In this way, the AMF may update the radio capability information of the terminal device according to the received first capability deletion information and notify the UCMF.

In some examples of the present disclosure, the AMF may further send new first local radio capability information to the access network device. Particularly, the new first local radio capability information is the first local radio capability information with the one or more disabled radio capabilities of the terminal device deleted according to the first capability deletion information.

In some other examples, the AMF may send third capability deletion information to the access network device according to the first capability deletion information. Similarly, the third capability deletion information may be the same as or different from the first capability deletion information.

In this way, the AMF may update the radio capability information of the terminal device according to the received first capability deletion information and notify the access network device.

FIG. 12 is a flowchart illustrating a terminal capability reporting method according to an example. As illustrated in FIG. 12, the method may include steps S1201-S1203.

At S1201, the AMF receives an NAS message sent by the terminal device via the access network device.

In some examples, the NAS message may include the radio capability information and the indicator. The indicator may indicate that the radio capability information is partial radio capability information of the terminal device or full radio capability information of the terminal device.

In some examples, the NAS message may include the first radio capability information and the first indicator. The first indicator indicates that the first radio capability information is the partial radio capability information of the terminal device.

In some other examples, the NAS message may include the second radio capability information and the second indicator. The second indicator indicates that the second radio capability information is the full radio capability information of the terminal device.

In some other examples, the NAS message may include the first capability deletion information.

In some other examples, the NAS message may include the first radio capability information, the first indicator and the first capability deletion information.

In some examples, the NAS message may include a registration request message.

In some other examples, the NAS message may include a radio capability information update message.

In some examples, the NAS message may also include a terminal identity parameter, which may be used to uniquely identify the terminal device.

At S1202, the AMF sends a first message to the UCMF.

In a case that the NAS message includes the radio capability information and the indicator, the first message may include radio capability information to be sent to the UCMF, or include the radio capability information to be sent to the UCMF and an indicator to be sent to the UCMF. Particularly, the indicator to be sent to the UCMF may indicate that the radio capability information is the partial radio capability information of the terminal device or the full radio capability information of the terminal device.

In a case that the NAS message includes the first radio capability information and the first indicator, the first message may include third radio capability information, or include the third radio capability information and a third indicator. The third indicator indicates that the third radio capability information is the partial radio capability information of the terminal device.

In a case that the NAS message includes the second radio capability information and the second indicator, the first message may include fourth radio capability information, or include the fourth radio capability information and a fourth indicator. The fourth indicator indicates that the fourth radio capability information is the full radio capability information of the terminal device.

In a case that the NAS message includes the first capability deletion information, the first message may include second capability deletion information, or include updated first local radio capability information.

In a case that the NAS message includes the first radio capability information, the first indicator and the first capability deletion information, the first message may include the third radio capability information and the second capability deletion information, or include the third radio capability information, the third indicator and the second capability deletion information, or include the updated first local radio capability information.

In some examples, the first message may also include a terminal identity parameter.

In some examples, the first message may include a radio capability reporting message, and the AMF may also receive a radio capability response message (a UE radio capability information response) sent by the UCMF.

At S1203, the AMF sends a second message to the access network device.

In a case that the NAS message includes the first radio capability information and the first indicator, the second message may include fifth radio capability information, or include the fifth radio capability information and a fifth indicator.

In a case that the NAS message includes the second radio capability information and the second indicator, the second message may include sixth radio capability information, or include the sixth radio capability information and a sixth indicator.

In a case that the NAS message includes the first capability deletion information, the second message may include third capability deletion information, or include the updated first local radio capability information.

In a case that the NAS message includes the first radio capability information, the first indicator and the first capability deletion information, the second message may include the fifth radio capability information and the third capability deletion information, or include the fifth radio capability information, the fifth indicator and the third capability deletion information, or include the updated first local radio capability information.

In some examples, the second message may also include a terminal identity parameter.

In some examples, the second message may be an N2 interface message.

It is to be noted that, in the example, both S1102 and S1103 may be canceled.

In this way, the AMF may update the partial radio capability information of the terminal device or the full radio capability information of the terminal device according to the received NAS message, and notify the UCMF and/or the access network device.

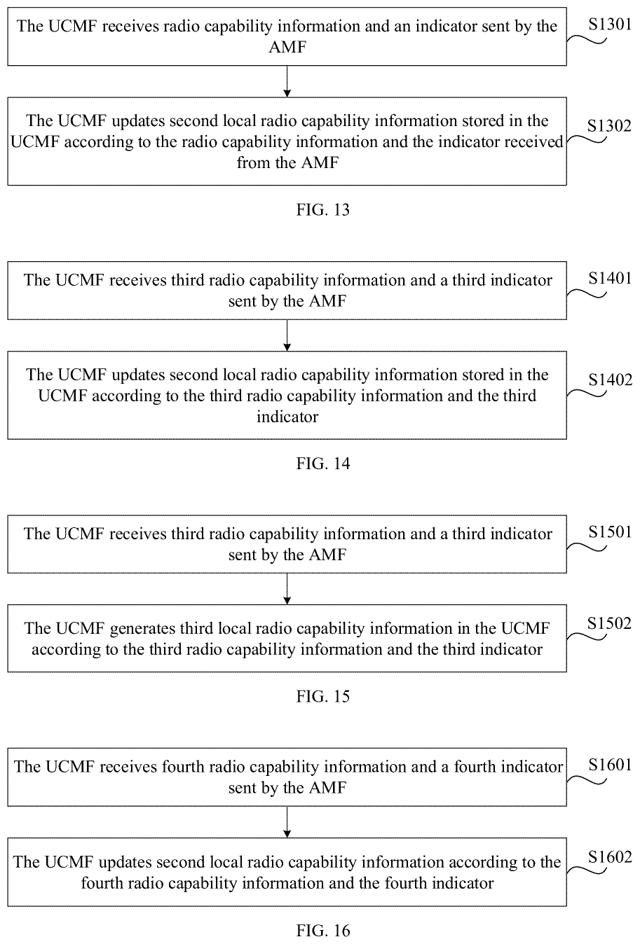

FIG. 13 is a flowchart illustrating a terminal capability reporting method according to an example. The method may be applied to the UCMF in the foregoing communication system. As illustrated in FIG. 13, the method may include steps S1301-S1302.

At S1301, the UCMF receives radio capability information and an indicator sent by the AMF.

Particularly, the indicator indicates that the radio capability information is partial radio capability information of the terminal device or full radio capability information of the terminal device.

At S1302, the UCMF updates second local radio capability information stored in the UCMF according to the radio capability information and the indicator received from the AMF.

Particularly, the second local radio capability information may include the full radio capability information of the terminal device.

For example, the UCMF may update the part of the second local radio capability information stored locally that is related to the radio capability information received from the AMF.

Through the method, the UCMF may update the partial radio capability information of the terminal device or the full radio capability information of the terminal device.

In some examples, the UCMF may receive the radio capability information and the indicator sent by the AMF through a radio capability reporting message.

In some other examples, the UCMF may further send a radio capability response message to the AMF. The radio capability response message indicates that the second local radio capability information stored in the UCMF has been successfully updated.

In some examples, the radio capability information received from the AMF may include third radio capability information, the indicator received from the AMF may include a third indicator, and the third indicator indicates that the third radio capability information is the partial radio capability information of the terminal device. In this way, the UCMF may generate third local radio capability information in the UCMF according to the third radio capability information and the third indicator.

In some other examples, the radio capability information received from the AMF includes fourth radio capability information, the indicator received from the AMF includes a fourth indicator, and the fourth indicator indicates that the fourth radio capability information is the full radio capability information of the terminal device. In this way, The UCMF may update the second local radio capability information according to the fourth radio capability information and the fourth indicator.

FIG. 14 is a flowchart illustrating a terminal capability reporting method according to an example. The method may be applied to the UCMF in the foregoing communication system. As illustrated in FIG. 14, the method may include steps S1401-S1402.

At S1401, the UCMF receives third radio capability information and a third indicator sent by the AMF.

Particularly, the third indicator indicates that the third radio capability information is partial radio capability information of the terminal device.

At S1402, the UCMF updates second local radio capability information stored in the UCMF according to the third radio capability information and the third indicator.

Particularly, the second local radio capability information may include the full radio capability information of the terminal device.

For example, the UCMF may update the part of the second local radio capability information stored locally that is related to the third radio capability information.

Through the method, the UCMF may update the partial radio capability information of the terminal device.

In some examples, the UCMF may receive the third radio capability information and the third indicator sent by the AMF through a radio capability reporting message.

In some other examples, the UCMF may further send a radio capability response message to the AMF. The radio capability response message indicates that the second local radio capability information stored in the UCMF has been successfully updated.

FIG. 15 is a flowchart illustrating a terminal capability reporting method according to an example. As illustrated in FIG. 15, the method may include steps S1501-S1502.

At S1501, the UCMF receives third radio capability information and a third indicator sent by the AMF.

Particularly, the third indicator indicates that the third radio capability information is partial radio capability information of the terminal device.

At S1502, the UCMF generates third local radio capability information in the UCMF according to the third radio capability information and the third indicator.

Particularly, the third local radio capability information includes the third radio capability information and the third indicator.

In this way, the UCMF may store the partial radio capability information of the terminal device.

FIG. 16 is a flowchart illustrating a terminal capability reporting method according to an example. As illustrated in FIG. 16, the method may include steps S1601-S1602.

At S1601, the UCMF receives fourth radio capability information and a fourth indicator sent by the AMF.

Particularly, the fourth indicator indicates that the fourth radio capability information is full radio capability information of the terminal device.

At S1602, the UCMF updates second local radio capability information according to the fourth radio capability information and the fourth indicator.

In this way, UCMF may update the full radio capability information of the terminal device.

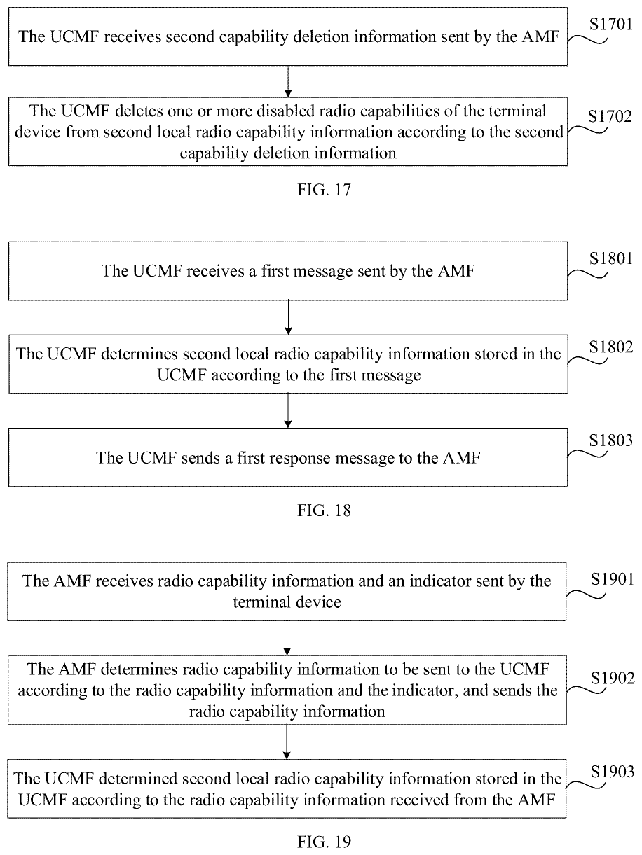

FIG. 17 is a flowchart illustrating a terminal capability reporting method according to an example. As illustrated in FIG. 17, the method may include steps S1701-S1702.

At S1701, the UCMF receives second capability deletion information sent by the AMF.

Particularly, the second capability deletion information indicates that part of radio capabilities of the terminal device are disabled.

Particularly, the second capability deletion information may be determined by the AMF according to first capability deletion information received from the terminal.

At S1702, the UCMF deletes one or more disabled radio capabilities of the terminal device from second local radio capability information according to the second capability deletion information.

In this way, the UCMF may delete the one or more disabled radio capabilities of the terminal device according to the second capability deletion information.

FIG. 18 is a flowchart illustrating a terminal capability reporting method according to an example. As illustrated in FIG. 18, the method may include steps S1801-S1803.

At S1801, the UCMF receives a first message sent by the AMF.

In some examples, the first message may include radio capability information.

For example, the radio capability information received from the AMF may include third radio capability information or fourth radio capability information. The third radio capability information is partial radio capability information of the terminal device; and the fourth radio capability information is full radio capability information of the terminal device.

In some other examples, the first message may include the radio capability information and an indicator. The indicator received from the AMF indicates that the radio capability information is the partial radio capability information of the terminal device or the full radio capability information of the terminal device.

In one implementation, the first message may include the third radio capability information and a third indicator. The third indicator indicates that the third radio capability information is the partial radio capability information of the terminal device.

In another implementation, the first message may include the fourth radio capability information and a fourth indicator. The fourth indicator indicates that the fourth radio capability information is the full radio capability information of the terminal device.

In some other examples, the first message may include the second capability deletion information.

In some other examples, the first message may further include the updated first local radio capability information.

In some other examples, the first message may include the third radio capability information and the second capability deletion information.

In some other examples, the first message may include the third radio capability information, the third indicator and the second capability deletion information.

In some examples, the first message may also include the terminal identity parameter.

In some examples, the first message may be a radio capability reporting message.

At S1802, the UCMF determines second local radio capability information stored in the UCMF according to the first message.

In some examples, the second local radio capability information may include the full radio capability information of the terminal device.

In a case that the first message includes the third radio capability information and the third indicator, the UCMF may generate third local radio capability information and update the second local radio capability information. Particularly, the third local radio capability information includes the third radio capability information and the third indicator.

At S1803, the UCMF sends a first response message to the AMF.

In some examples, the first response message may be a radio capability response message.

In this way, the UCMF may update the locally stored radio capability information corresponding to the terminal device according to the first message.

FIG. 19 is a flowchart illustrating a terminal capability reporting method according to an example. The method may be applied to the core network device in the foregoing communication system, where the core network device may include the AMF and the UCMF. As illustrated in FIG. 19, the method may include steps S1901-S1903.

At S1901, the AMF receives radio capability information and an indicator sent by the terminal device.

Particularly, the indicator indicates that the radio capability information is partial radio capability information of the terminal device or full radio capability information of the terminal device.

At S1902, the AMF determines radio capability information to be sent to the UCMF according to the radio capability information and the indicator, and sends the radio capability information.

At S1903, the UCMF determined second local radio capability information stored in the UCMF according to the radio capability information received from the AMF.

It is to be noted that the detailed implementations of the steps in the example may make reference to the description in the previous examples of the present disclosure, which are not repeated here.

Through the method, the core network device may receive the radio capability information and the indicator sent by the terminal device, and update the locally stored radio capability information according to the radio capability information and the indicator. Particularly, the indicator indicates that the radio capability information is the partial radio capability information of the terminal device or the full radio capability information of the terminal device. In this way, the core network device may support the terminal devices to report only the partial radio capability information, which may reduce the occupancy of wireless resources and improve the communication efficiency of the communication system.

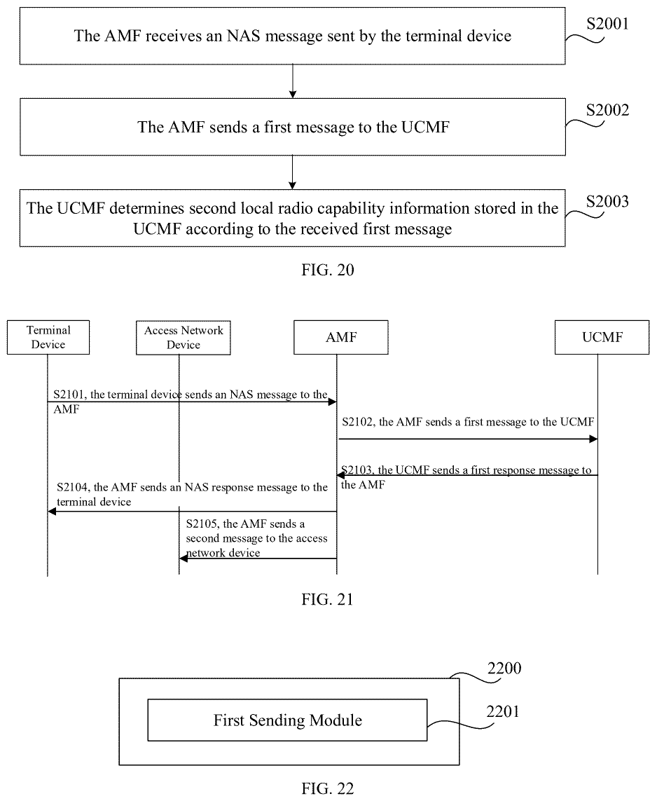

FIG. 20 is a flowchart illustrating a terminal capability reporting method according to an example. As illustrated in FIG. 20, the method may include steps S2001-S2003.

At S2001, the AMF receives an NAS message sent by the terminal device.

Particularly, the NAS message may include radio capability information of the terminal device and an indicator. The indicator indicates that the radio capability information is partial radio capability information of the terminal device or full radio capability information of the terminal device.

In some examples, the NAS message may include a registration request message or a radio capability information update message.

At S2002, the AMF sends a first message to the UCMF.

In some examples, the first message may include radio capability information.

For example, the radio capability information in the first message sent from the AMF to the UCMF may include third radio capability information or fourth radio capability information. The third radio capability information is the partial radio capability information of the terminal device; and the fourth radio capability information is the full radio capability information of the terminal device.

In some other examples, the first message may include the radio capability information and an indicator. The indicator received from the AMF indicates that the radio capability information is the partial radio capability information of the terminal device or the full radio capability information of the terminal device.

In one implementation, the first message may include the third radio capability information and a third indicator. The third indicator indicates that the third radio capability information is the partial radio capability information of the terminal device.

In another implementation, the first message may include the fourth radio capability information and a fourth indicator. The fourth indicator indicates that the fourth radio capability information is the full radio capability information of the terminal device.

Particularly, the first message may include radio capability information to be sent to the UCMF and an indicator to be sent to the UCMF. The indicator to be sent to the UCMF indicates that the radio capability information is the partial radio capability information of the terminal device or the full radio capability information of the terminal device.

At S2003, the UCMF determines second local radio capability information stored in the UCMF according to the received first message.

It is to be noted that the detailed implementations of the steps in the example may make reference to the description in the previous examples of the present disclosure, which are not repeated here.

Through the method, the AMF may receive the partial radio capability information or the full radio capability information sent by the terminal device through the NAS message, and notify the UCMF through the first message to update the partial radio capability information of the terminal device or the full radio capability information of the terminal device, which may support the terminal device to report only the partial radio capability information, thereby reducing the occupancy of radio resources and improving the communication efficiency of the communication system.

FIG. 21 is a flowchart illustrating a terminal capability reporting method according to an example. As illustrated in FIG. 21, the method may include steps S2101-S2105.

At S2101, the terminal device sends an NAS message to the AMF.

For example, the terminal device may send the NAS message to the AMF via the access network device. The NAS message may include a registration request message or a radio capability information update message.

In some examples, the NAS message may include the first radio capability information and the first indicator.

In some other examples, the NAS message may include the second radio capability information and the second indicator.

In some other examples, the NAS message may include the first capability deletion information.

In some other examples, the NAS message may include the first radio capability information, the first indicator and the first capability deletion information.

At S2102, the AMF sends a first message to the UCMF.

In some examples, the AMF may trigger a radio capability update according to the NAS message. For example, the AMF may update first local radio capability information stored locally, and send the first message for triggering the radio capability update to the UCMF.

At S2103, the UCMF sends a first response message to the AMF.

In some examples, the AMF may receive the first radio capability information and the first indicator sent by the terminal device through the NAS message. The first indicator indicates that the first radio capability information is partial radio capability information of the terminal device. The AMF may send third radio capability information to the UCMF according to the first radio capability information and the first indicator. The UCMF may determine second local radio capability information stored in the UCMF according to the received third radio capability information.

At S2104, the AMF sends an NAS response message to the terminal device.

In some examples, the NAS message may be a registration request message, and the NAS response message may be a registration response message.

In some other examples, the NAS message may be a radio capability information update message, and the NAS response message may be a radio capability information update response message.

At S2105, the AMF sends a second message to the access network device.

In some examples, the second message may be an N2 interface message.

In some examples, the NAS message, the first message and the second message may all include a terminal identity parameter.

It is to be noted that the detailed implementations of the steps in the example may make reference to the description in the previous examples of the present disclosure, which are not repeated here.

Through the method, the AMF may receive the partial radio capability information or the full radio capability information sent by the terminal device through the NAS message, notify the UCMF and/or the access network device, and update the partial radio capability information of the terminal device or the full radio capability information of the terminal device, which may support the terminal device to report only the partial radio capability information, thereby reducing the occupancy of radio resources and improving the communication efficiency of the communication system.

In some examples of the present disclosure, a core network device is further provided. The core network device may be the core network device illustrated in FIG. 1. The core network device may include the AMF and the UCMF.

Particularly, the AMF may be configured to receive first radio capability information and a first indicator sent by the terminal device, where the first indicator indicates that the first radio capability information is partial radio capability information of the terminal device; and send third radio capability information to the UCMF according to the first radio capability information and the first indicator.

The UCMF may be configured to determine second local radio capability information stored in the UCMF according to the received third radio capability information.

FIG. 22 is a block diagram illustrating a terminal capability reporting apparatus 2200 according to an example. The apparatus may be applied to a terminal device. As illustrated in FIG. 22, the apparatus 2200 may include a first sending module 2201.

The first sending module 2201 is configured to send radio capability information of the terminal device and an indicator to an AMF. The indicator indicates that the radio capability information is partial radio capability information of the terminal device or full radio capability information of the terminal device.

In some examples, the radio capability information is first radio capability information, the indicator is a first indicator, and the first indicator indicates that the first radio capability information is the partial radio capability information of the terminal device.

In some examples, the first sending module 2201 is configured to determine, in a case that the partial radio capability information of the terminal device changes, the first radio capability information according to the partial radio capability information that is changed; and send the first radio capability information and the first indicator to the AMF.

In some examples, the radio capability information is second radio capability information, the indicator is a second indicator, and the second indicator indicates that the second radio capability information is the full radio capability information of the terminal device. The first sending module 2201 is configured to send the second radio capability information of the terminal device and the second indicator to the AMF.

In some examples, the first sending module 2201 is further configured to send first capability deletion information to the AMF. The first capability deletion information indicates that part of radio capabilities of the terminal device are disabled.

In some examples, the first sending module 2201 is configured to send an NAS message to the AMF via an access network device. The NAS message includes the radio capability information and the indicator.

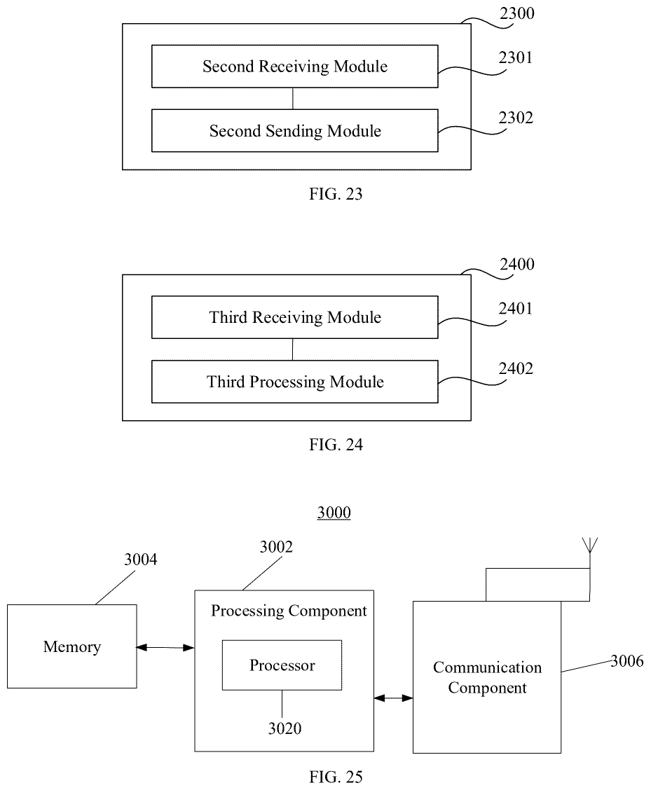

FIG. 23 is a block diagram illustrating a terminal capability reporting apparatus 2300 according to an example. The apparatus may be applied to an AMF. As illustrated in FIG. 23, the apparatus 2300 may include a second receiving module 2301 and a second sending module 2302.

The second receiving module 2301 is configured to receive radio capability information and an indicator sent by a terminal device, where the indicator indicates that the radio capability information is partial radio capability information of the terminal device or full radio capability information of the terminal device.

The second sending module 2302 is configured to determine, according to the radio capability information and the indicator, radio capability information to be sent to a UCMF, and send the radio capability information to the UCMF.

In some examples, the second sending module 2302 is configured to determine, according to the radio capability information and the indicator, the radio capability information to be sent to the UCMF and an indicator to be sent to the UCMF, and send the radio capability information and the indicator to the UCMF. The indicator indicates that the radio capability information to be sent to the UCMF is the partial radio capability information of the terminal device or the full radio capability information of the terminal device.

In some examples, the radio capability information includes first radio capability information, the indicator includes a first indicator, and the first indicator indicates that the first radio capability information is the partial radio capability information of the terminal device. The second sending module 2302 is configured to determine, according to the first radio capability information and the first indicator, third radio capability information and a third indicator to be sent to the UCMF. The third indicator indicates that the third radio capability information is the partial radio capability information of the terminal device.

In some examples, the radio capability information includes second radio capability information, the indicator includes a second indicator, and the second indicator indicates that the second radio capability information is the full radio capability information of the terminal device. The second sending module 2302 is configured to determine, according to the second radio capability information and the second indicator, fourth radio capability information and a fourth indicator to be sent to the UCMF. The fourth indicator indicates that the fourth radio capability information is the full radio capability information of the terminal device.

In some examples, the second sending module 2302 is configured to update, according to the radio capability information and the indicator, first local radio capability information stored in the AMF, wherein the first local radio capability information includes the full radio capability information of the terminal device; and take updated first local radio capability information as the radio capability information to be sent to the UCMF.

In some examples, the second receiving module 2301 is further configured to receive first capability deletion information sent by the terminal device. The first capability deletion information indicates that part of radio capabilities of the terminal device are disabled.

The second sending module 2302 is further configured to delete, according to the first capability deletion information, one or more disabled radio capabilities of the terminal device from the first local radio capability information stored in the AMF. The first local radio capability information includes the full radio capability information of the terminal device.

In some examples, the second sending module 2302 is further configured to send new first local radio capability information to the UCMF.

In some examples, the second sending module 2302 is further configured to send, according to the first capability deletion information, second capability deletion information to the UCMF.

In some examples, the second receiving module 2301 is configured to receive, via an access network device, an NAS message sent by the terminal device. The NAS message includes the radio capability information and the indicator.

In some examples, the second sending module 2302 is further configured to send fifth radio capability information to the access network device.

FIG. 24 is a block diagram illustrating a terminal capability reporting apparatus 2400 according to an example. The apparatus may be applied to a UCMF. As illustrated in FIG. 24, the apparatus 2400 may include a third receiving module 2401 and a third processing module 2402.

The third receiving module 2401 is configured to receive radio capability information and an indicator sent by an AMF, where the indicator indicates that the radio capability information is partial radio capability information of a terminal device or full radio capability information of the terminal device.

The third processing module 2402 is configured to update, according to the radio capability information and the indicator received from the AMF, second local radio capability information stored in the UCMF, where the second local radio capability information includes the full radio capability information of the terminal device.

In some examples, the radio capability information received from the AMF includes third radio capability information, the indicator received from the AMF includes a third indicator, and the third indicator indicates that the third radio capability information is the partial radio capability information of the terminal device. The third processing module 2402 is further configured to generate, according to the third radio capability information and the third indicator, third local radio capability information in the UCMF. The third local radio capability information includes the third radio capability information and the third indicator.

In some examples, the radio capability information received from the AMF includes fourth radio capability information, the indicator received from the AMF includes a fourth indicator, and the fourth indicator indicates that the fourth radio capability information is the full radio capability information of the terminal device. The third processing module 2402 is configured to update, according to the fourth radio capability information and the fourth indicator, the second local radio capability information.

In some examples, the third processing module 2402 is configured to receive second capability deletion information sent by the AMF, where the second capability deletion information indicates that part of radio capabilities of the terminal device are disabled; and delete, according to the second capability deletion information, one or more disabled radio capabilities of the terminal device from the second local radio capability information.

With respect to the apparatuses in the foregoing examples, the detailed scheme in which each module performs its operations has been described in detail in the examples of the related methods, and will not be described in detail here.

FIG. 25 is a block diagram illustrating a terminal capability reporting apparatus according to an example. The terminal capability reporting apparatus 3000 may be the terminal device in the communication system illustrated in FIG. 1, or may be the AMF or the UCMF in the communication system.

Referring to FIG. 25, the apparatus 3000 may include one or more of the following components: a processing component 3002, a memory 3004, and a communication component 3006.

The processing component 3002 may generally control the overall operations of the apparatus 3000, such as operations associated with display, phone calls, data communications, camera operations, and recording operations. The processing component 3002 may include one or more processors 3020 to execute instructions to complete all or part of the steps of the foregoing terminal capability reporting methods. In addition, the processing component 3002 may include one or more modules which facilitate the interactions between the processing component 3002 and other components. For example, the processing component 3002 may include a multimedia module to facilitate the interactions between a multimedia component and the processing component 3002.

The memory 3004 is configured to store various types of data to support the operations of the apparatus 3000. Examples of such data include instructions for any application or method operated on the apparatus 3000, contact data, phonebook data, messages, pictures, videos, and the like. The memory 3004 may be implemented by any type of volatile or non-volatile storage device or a combination thereof, such as a static random access memory (SRAM), an electrically erasable programmable read-only memory (EEPROM), an erasable and programmable read-only memory (EPROM), a programmable read-only memory (PROM), a read-only memory (ROM), a magnetic memory, a flash memory, a magnetic disk or an optical disk.

The communication component 3006 is configured to facilitate wired or wireless communications between the apparatus 3000 and other devices. The apparatus 3000 may access a wireless network based on a communication standard, such as Wi-Fi, 2G, 3G, 4G, 5G, 6G, narrow band Internet of Things (NB-IOT), enhanced machine type communication (eMTC), etc., or a combination thereof. In an example, the communication component 3006 receives broadcast signals or broadcast related information from an external broadcast management system via a broadcast channel. In an example, the communication component 3006 also includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth® (BT) technology and other technologies.

In one or more examples, the apparatus 3000 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components for performing the foregoing terminal capability reporting methods.

The apparatus 3000 may be an independent electronic device or a part of an independent electronic device. For example, in an example, the electronic device may be an integrated circuit (IC) or a chip. The integrated circuit may be one IC or a set of multiple ICs. The chip may include but not limited to the following types: a graphics processing unit (GPU), a central processing unit (CPU), an FPGA, a DSP, an ASIC, a system on chip (SoC), etc. The integrated circuit or chip may be used to execute executable instructions (or codes) to implement the foregoing terminal capability reporting methods. The executable instructions may be stored in the integrated circuit or chip, or may be obtained from another apparatus or device. For example, the integrated circuit or chip includes one or more processors, one or more memories, and one or more interfaces for communicating with other apparatuses. The executable instructions may be stored in the one or more processors, and when executed by the one or more processors, implement the foregoing terminal capability reporting methods. Alternatively, the integrated circuit or chip may receive the executable instructions through the one or more interfaces and transmit them to the one or more processors for execution, so as to implement the foregoing terminal capability reporting methods.

In one or more examples, the present disclosure further provides a computer-readable storage medium, on which computer program instructions are stored. The program instructions, when executed by one or more processors, implement the steps of the terminal capability reporting methods provided in the present disclosure. For example, the computer-readable storage medium may be a non-transitory computer-readable storage medium including instructions, e.g., the memory 3004 including the instructions. The instructions may be executed by the processor 3020 of the apparatus 3000 to complete the foregoing terminal capability reporting methods. For example, the non-transitory computer-readable storage medium may be ROM, random access memory (RAM), compact disc read-only memory (CD-ROM), magnetic tape, floppy disk, optical data storage device, and the like.

In another example, a computer program product is further provided. The computer program product includes a computer program that may be executed by a programmable device. The computer program has a code portion for performing the terminal capability reporting methods when executed by the programmable device.

Other implementations of the present disclosure will be readily apparent to those skilled in the art after implementing the disclosure by referring to the specification. The present disclosure is intended to cover any variations, uses, or adaptations of the present disclosure that are in accordance with the general principles thereof and include common general knowledge or conventional technical means in the art that are not disclosed in the present disclosure. The specification and examples therein are only illustrative, and the true scope and spirit of the present disclosure are to be indicated by appended claims.

It is to be understood that the present disclosure is not limited to the above-described accurate structures illustrated in the drawings, and various modifications and changes can be made to the present disclosure without departing from the scope thereof. The scope of the present disclosure is to be limited only by the appended claims.

1. A terminal capability reporting method, performed by a terminal device, comprising:
sending radio capability information of the terminal device and an indicator to an access and mobility management function (AMF), wherein the indicator indicates that the radio capability information is partial radio capability information of the terminal device or full radio capability information of the terminal device.

2. The method according to claim 1, wherein the radio capability information is first radio capability information, the indicator is a first indicator, and the first indicator indicates that the first radio capability information is the partial radio capability information of the terminal device.

3. The method according to claim 2, wherein sending the radio capability information of the terminal device and the indicator to the AMF comprises:
determining, in a case that the partial radio capability information of the terminal device changes, the first radio capability information according to the partial radio capability information that is changed; and
sending the first radio capability information and the first indicator to the AMF.

4. The method according to claim 1, wherein the radio capability information is second radio capability information, the indicator is a second indicator, and the second indicator indicates that the second radio capability information is the full radio capability information of the terminal device.

5. The method according to claim 1, further comprising:
sending first capability deletion information to the AMF, wherein the first capability deletion information indicates that part of radio capabilities of the terminal device are disabled.

6. The method according to claim 1, wherein sending the radio capability information of the terminal device and the indicator to the AMF comprises:
sending a non-access stratum (NAS) message to the AMF via an access network device, wherein the NAS message comprises the radio capability information and the indicator.

7. A terminal capability reporting method, performed by an access and mobility management function (AMF), comprising:
receiving radio capability information and an indicator sent by a terminal device, wherein the indicator indicates that the radio capability information is partial radio capability information of the terminal device or full radio capability information of the terminal device; and
determining, according to the radio capability information and the indicator, radio capability information to be sent to user equipment radio capability management function (UCMF), and sending the radio capability information to the UCMF.

8. The method according to claim 7, wherein determining, according to the radio capability information and the indicator, the radio capability information to be sent to the UCMF comprises:
determining, according to the radio capability information and the indicator, the radio capability information to be sent to the UCMF and an indicator to be sent to the UCMF, and
sending the radio capability information and the indicator to the UCMF, wherein the indicator indicates that the radio capability information to be sent to the UCMF is the partial radio capability information of the terminal device or the full radio capability information of the terminal device.

9. The method according to claim 8,
wherein the radio capability information comprises first radio capability information, the indicator comprises a first indicator, and the first indicator indicates that the first radio capability information is the partial radio capability information of the terminal device; and
wherein determining, according to the radio capability information and the indicator, the radio capability information to be sent to the UCMF and the indicator to be sent to the UCMF comprises:
determining, according to the first radio capability information and the first indicator, third radio capability information and a third indicator to be sent to the UCMF, wherein the third indicator indicates that the third radio capability information is the partial radio capability information of the terminal device; or
wherein the radio capability information comprises second radio capability information, the indicator comprises a second indicator, and the second indicator indicates that the second radio capability information is the full radio capability information of the terminal device; and wherein determining, according to the radio capability information and the indicator, the radio capability information to be sent to the UCMF and the indicator to be sent to the UCMF comprises:
determining, according to the second radio capability information and the second indicator, fourth radio capability information and a fourth indicator to be sent to the UCMF, wherein the fourth indicator indicates that the fourth radio capability information is the full radio capability information of the terminal device.

10. (canceled)

11. The method according to claim 7, wherein determining, according to the radio capability information and the indicator, the radio capability information to be sent to the UCMF comprises:
updating, according to the radio capability information and the indicator, first local radio capability information stored in the AMF, wherein the first local radio capability information comprises the full radio capability information of the terminal device; and
taking the updated first local radio capability information as the radio capability information to be sent to the UCMF.

12. The method according to claim 7, further comprising:
receiving first capability deletion information sent by the terminal device, wherein the first capability deletion information indicates that part of radio capabilities of the terminal device are disabled; and
deleting, according to the first capability deletion information, one or more disabled radio capabilities of the terminal device from first local radio capability information stored in the AMF, wherein the first local radio capability information comprises the full radio capability information of the terminal device.

13. The method according to claim 12, further comprising:
sending new first local radio capability information to the UCMF after deleting the one or more disabled radio capabilities of the terminal device from the first local radio capability information stored in the AMF; or
sending, according to the first capability deletion information, second capability deletion information to the UCMF after receiving the first capability deletion information sent by the terminal device.

14. (canceled)

15. The method according to claim 7, wherein receiving the radio capability information and the indicator sent by the terminal device comprises:
receiving, via an access network device, a non-access stratum (NAS) message sent by the terminal device, wherein the NAS message comprises the radio capability information and the indicator.

16. The method according to claim 7, further comprising:
sending fifth radio capability information to an access network device.

17. A terminal capability reporting method, performed by a user equipment radio capability management function (UCMF), comprising:
receiving radio capability information and an indicator sent by an access and mobility management function (AMF), wherein the indicator indicates that the radio capability information is partial radio capability information of a terminal device or full radio capability information of the terminal device; and
updating, according to the radio capability information and the indicator received from the AMF, second local radio capability information stored in the UCMF, wherein the second local radio capability information comprises the full radio capability information of the terminal device.

18. The method according to claim 17,
wherein the radio capability information received from the AMF comprises third radio capability information, the indicator received from the AMF comprises a third indicator, and the third indicator indicates that the third radio capability information is the partial radio capability information of the terminal device; and
wherein the method further comprises:
generating, according to the third radio capability information and the third indicator, third local radio capability information in the UCMF, wherein the third local radio capability information comprises the third radio capability information and the third indicator; or
wherein the radio capability information received from the AMF comprises fourth radio capability information, the indicator received from the AMF comprises a fourth indicator, and the fourth indicator indicates that the fourth radio capability information is the full radio capability information of the terminal device; and wherein updating, according to the radio capability information and the indicator received from the AMF, the second local radio capability information stored in the UCMF comprises:
updating, according to the fourth radio capability information and the fourth indicator, the second local radio capability information.

19. (canceled)

20. The method according to claim 17, further comprising:
receiving second capability deletion information sent by the AMF, wherein the second capability deletion information indicates that part of radio capabilities of the terminal device are disabled; and
deleting, according to the second capability deletion information, one or more disabled radio capabilities of the terminal device from the second local radio capability information.

21-25. (canceled)

26. A terminal device, comprising:
one or more processors; and
one or more memories for storing instructions executable by the one or more processors;
wherein the one or more processors are configured to perform steps of the method according to claim 1.

27. (canceled)

28. An access and mobility management function (AMF), comprising:
one or more processors; and
one or more memories for storing instructions executable by the one or more processors;
wherein the one or more processors are configured to perform the method according to claim 7.

29. A user equipment radio capability management function (UCMF), comprising:
one or more processors; and
one or more memories for storing instructions executable by the one or more processors;
wherein the one or more processors are configured to perform the method according to claim 17.
